(19) United States
(12) Patent Application Publication
(10) Pub. No.: US 2013/0215617 A1
(43) Pub. Date: Aug. 22, 2013

(54) Lighting Apparatus and Method of Skull Lighting

(71) Applicant: Michael E. Carroll, Hamburg, NY (US)

(72) Inventor: Michael E. Carroll, Hamburg, NY (US)

(73) Assignee: Old Goat Outdoors LLC, Hamburg, NY (US)

(21) Appl. No.: 13/773,698

(22) Filed: Feb. 22, 2013

Related U.S. Application Data
(60) Provisional application No. 61/601,914, filed on Feb. 22, 2012.
(60) Provisional application No. 61/696,371, filed on Sep. 4, 2012.

(51) Int. Cl. F21V 33/00; H01R 43/26

(52) U.S. Cl. CPC F21V 33/0028; H01R 43/26
USPC 362/253; 362/362; 362/382; 29/825

(57) ABSTRACT

A lighting apparatus is provided that includes a lighting harness having a harness power cord. Disposed internal to the harness power cord are pairs of electrical leads for providing electrical power to LED's. The harness power cord is plugged into a switch. There is also a power source cord having a first power cord source end that is plugged into the switch and the power source cord has a second power cord source end that is connected to a transformer. The transformer is capable of being plugged into a wall receptacle. The lighting harness is disposed internal to the skull of an animal such that the LED's are capable of illuminating the skull when supplied with electric power via the lighting harness.

### CROSS-REFERENCE TO RELATED APPLICATIONS

This application claims the benefit of U.S. Provisional Application No. 61/601,914, filed Feb. 22, 2012, and claims the benefit of U.S. Provisional Application No. 61/696,371, filed Sep. 4, 2012, the disclosures of which are incorporated herein by reference.

### FIELD OF INVENTION

This invention is directed to a lighting apparatus and method of lighting particularly suitable for lighting the interior of a three-dimensional cavernous structure.

### BACKGROUND OF INVENTION

Three-dimensional cavernous structures can be difficult to light for ornamental purposes. Examples of three-dimensional cavernous structures can include sculptures and animal skulls, either of which may be translucent. Such structures typically need to be lit from the inside, but if the light source is too close to the material of the structure, the light may run too hot thereby damaging or deteriorating the interior of the structure. As a result, in some instances, the decision is made to not light the structure rather than risk damaging or deteriorating the structure.

Another problem with lighting three-dimensional cavernous structures is finding a light source that is capable of evenly distributing the light so that the entire structure is well-illuminated, rather than one intense light source that does not allow for adequate observation of a structure's ornate detail.

Thus, it is desirable to provide a lighting apparatus capable of lighting the interior of a three-dimensional cavernous structure without damaging or deteriorating the interior, while providing adequate light distribution.

European mounts or skull mounts for use in connection with mounting are animal heads, for example deer, elk, and bear heads. If the animal is antlered, the antlers are typically left intact. Animal skulls can also be mounted on such mounts. The skulls are cleaned of all flesh and soft tissue through a boiling process, and then the skull is typically bleached. There are other well-known methods for removing tissue from a skull.

Although the bleached skull is white, after it has been mounted it may appear dark, and it is visually difficult to distinguish the features of the skull. Indeed, in dimly or darkly lit areas the mounted skull may not appear very attractive. Presently, there are no effective ways to improve the appearance of a mounted skull.

Thus, it would be desirable to improve the appearance of a mounted skull to make it more aesthetically appealing and impressive.

### SUMMARY OF THE INVENTION

Accordingly, it is the subject of this invention to provide a lighting apparatus capable of lighting the interior of a three-dimensional cavernous structure without damaging or deteriorating the interior, while providing adequate light distribution.

Although the lighting apparatus disclosed herein is described in connection with a skull and a skull mount, it will be appreciated that the lighting apparatus may also be used with any other suitable three-dimensional cavernous structure.

European mounting is a method commonly employed to mount a skull such that it can be displayed on, for example, a wall. Recent advances in light emitting diode (hereinafter referred to as LED) technology make it possible to produce significant light intensity with minimal heat. Thus, LED lights can be mounted in close proximity to valuable objects without the risk of burning or damaging or deteriorating the objects.

The present lighting apparatus and mount includes a wiring harness, a switch and an AC adapter in one of the preferred embodiments. The lighting harness is installed internal to the skull and the wiring harness includes a plurality of LED's.

When power is supplied to the LED's they emit light that illuminates the bones of the skull, as well as emit light through the eye and nose openings defined in the skull. Depending on the transparency of the skull, the emitted light may be seen through the bone. The LED's can be embodied to have virtually any desired color. The skull can be mounted on a European style mount or other suitable mount, and the switch allows the user to select 120V or 220V.

In other preferred embodiments there are light sensors, motion sensors, and audio chips that are incorporated into the lighting apparatus.

In other preferred embodiments the wiring harness can be powered by a direct current via a DC battery, and may be powered by solar power.

### BRIEF DESCRIPTION OF THE DRAWINGS

FIG. 1 is a diagrammatic view of the components of a lighting apparatus.

FIG. 2 is a sectional view of a switch for use in the lighting apparatus taken along line X-X of FIG. 1.

FIG. 3 is a view of a circuit for use in the switch.

FIG. 4 is a front view of a deer skull wherein the lighting apparatus is installed in a deer skull.

FIG. 5 is a perspective view of a European mount attached to a wall for use in connection with the deer skull shown in FIG. 4.

FIG. 6 is a perspective view of a mount supported on a flat surface for use in connection with the deer skull shown in FIG. 4.

FIG. 7 is a rear view of a table mount supported on a flat surface.

### DETAILED DESCRIPTION OF THE INVENTION

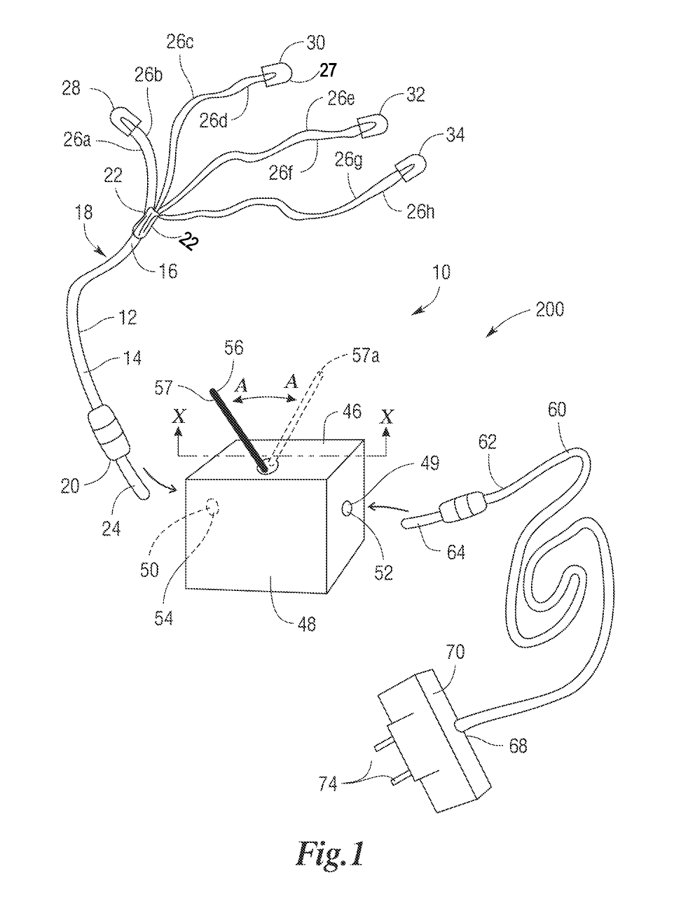

Turning now to FIG. 1, shown therein are the components of the lighting apparatus 10. The lighting apparatus 10 includes a lighting harness 12 that includes a harness power cord 14. The harness power cord 14 has an outer casing 16 that provides for insulation, and disposed internal to the outer casing 16 are a plurality of electrical leads 18. In one of the preferred embodiments the plurality of electrical leads 18 are in the form of pairs of first, second, third and fourth electric leads 26a, 26b, 26c, 26d, 26e, 26f, 26g, 26h. The harness power cord 14 also has opposed first and second harness power cord ends 20, 22. The first power cord end 20 has attached to it an electric socket 24. The second end 22 of the harness power cord 14 is joined to a wire guide component 22a. As shown, the pairs of first, second, third and fourth electric leads 26a, 26b, 26c, 26d, 26e, 26f, 26g, 26h extend through the wire guide component 22a such that they are disposed outside the outer casing 16 and exposed in that they are no longer disposed internal to the outer casing 16. The pairs of first, second, third and fourth electric leads 26a, 26b, 26c, 26d, 26e, 26f, 26g, 26h that extend beyond the wire guide component 22a are capable of branching out from one another.

The lighting harness 12 also includes a light source 27. In one of the preferred embodiments the light source 27 is in the form of a LED. Attached to the first pair of electric leads 26a, 26b is a first LED 28, attached to the second pair of electric leads 26c, 26d is a second LED 30, attached to the third pair of electric leads 26e, 26f is a third LED 32, and attached to the fourth pair of electric leads 26g, 26h is a fourth LED 34. It is to be understood that in other preferred embodiments there may be more or less than four pairs of electric leads and more or less than four LED's. The use and operation of an LED is well known to those having ordinary skill in the art and is therefore not described in greater detail herein.

The first, second, third and fourth LED's 28, 30, 32, 34 can be made so as to be able to emit any desired color of light. Thus, the coloring of the LED's is not limited to white light or any particular color. It is pointed out that the electric socket 24 is for delivering electrical power to the pairs first, second, third and fourth electric leads 26a, 26b, 26c, 26d, 26e, 26f, 26g, 26h.

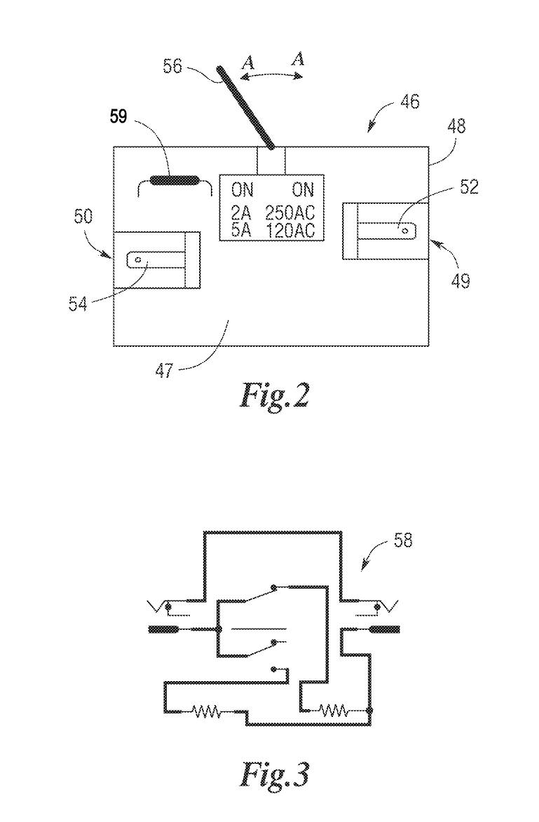

As shown in FIGS. 2-3, the lighting apparatus 10 further includes a switch assembly 46. The switch assembly 46 includes a housing 48, and the housing 48 defines inlet and outlet openings 49, 50. Aligned with the inlet opening 49 and disposed internal to the housing 48 is a first plug 52, and aligned with the outlet opening 50 and disposed internal to the housing 48 is a second plug 54. The switch assembly 46 also includes a switch 56 that is movable from a first switch position 57 (for 2 amps, 250 volts) to a second switch position 57a (for 5 amp, 120 volts) shown in dashed lines, and as indicated by the arrow designated A-A in FIGS. 1 and 2. The switch assembly 46 also includes a board 47 and a resistor 59. To assemble, the switch 56 is soldered to the board 47, the first and second plugs 52, 54 are soldered to the board 47, and the resistor is soldered to the board 47. FIG. 3 is a diagram of a circuit board 58 for use in the switch assembly 46. The construction, use and operation of circuit boards is well known to those having ordinary skill in the art and is therefore not described in greater detail herein.

The above-described electric socket 24 is capable of being fitted on the second plug 54 such that electrical power can be delivered to the first, second, third and fourth LED's 28, 30, 32, 34.

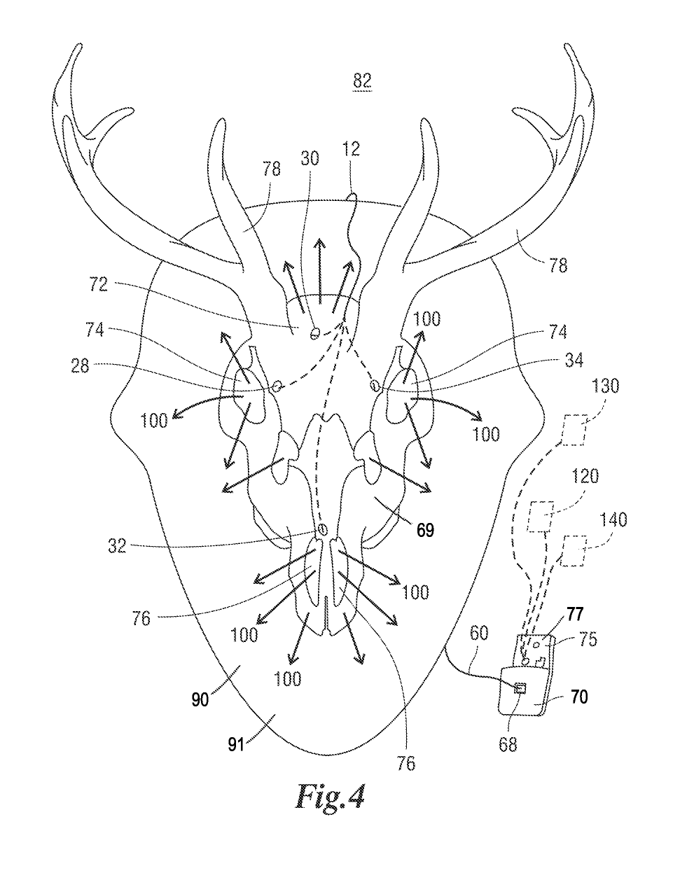

As shown in FIG. 1, the lighting apparatus 10 also includes a power source cord 60 having a first power cord source end 62, and a second electric socket 64 is attached to the first power cord source end 62. The second electric socket 64 is capable of being fitted on the first plug 52 disposed in the housing 48 such that electrical power can be delivered to the switch assembly 46. There is also a second power cord source end 68 that is connected to a transformer 70, and the transformer 70 has prongs 74 adapted to be inserted into, for example, a standard wall receptacle 75 (see FIG. 4). The standard wall receptacle 75 provides an external power source 77 in the form of alternating current for powering the lighting apparatus 10. Transformers are well known to those having ordinary skill in the art and are not described in greater detail herein.

Thus, when the transformer 74 is plugged into the wall receptacle 75, and the second electric socket 64 is moved onto the first plug 52, and the switch 56 is moved to the appropriate position, and the electric socket 24 is moved onto the second plug 54, and electrical power is delivered to the first, second, third and fourth LED's 28, 30, 32, 34 causing them to emit light 100 (see FIG. 4).

As shown in FIG. 4, there is a housing 69 that is in the form of a skull 72 that is embodied as a deer skull. It will be appreciated that the skull may be a real, synthetic, or artificial skull. The skull 72 defines eye socket openings 74 and nostril openings 76, and antlers 78 extend from the skull 72.

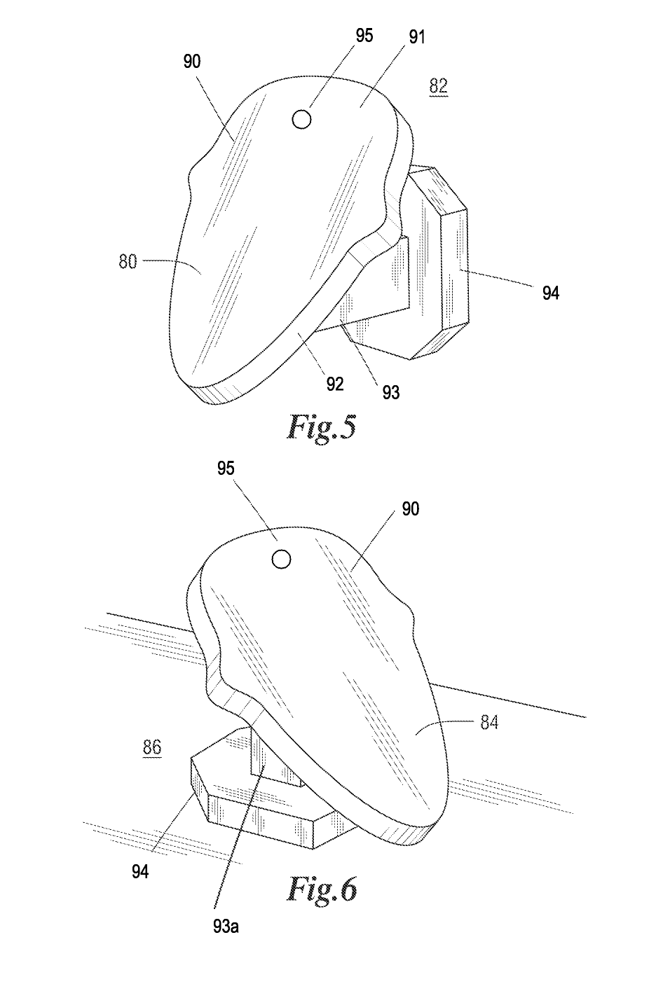

As shown in FIG. 5, the skull 72 is supported on a wall mount (embodied herein as a European style head mount) that is connected to a wall 82. In another preferred embodiment, shown in FIG. 6, there is a table mount 84 that supports the skull 72.

The wall mount 80 includes a plaque 90 to which the skull 72 is connected, for example with glue or fasteners. The plaque 90 has opposed first and second sides 91, 92 and the skull 72 is connected to the first side 91 (as shown in FIG. 4). The second side 92 is connected to a connecting member 93, and the connecting member 93 is connected to a base member 94. The connecting member 93 is substantially perpendicular to the base member 94, and at an angle relative to the plaque 90.

The table mount 84 also has a plaque 90 and a base member 94 as described above. The plaque 90 is connected to a connecting member 93a, and the connecting member 93a is connected to a base member 94. The base member 94 is supported on a table or shelf 86.

In one of the preferred embodiments, the plaque 90 defines a plaque opening 95. The harness power cord 14 is capable of being fitted through the plaque opening 95.

To illuminate the skull 72 the lighting harness 12 is fitted and arranged in the skull 72, and the first, second, third and fourth LED's 28, 30, 32, 34 are provided with power such that light 100 (depicted as arrows in FIG. 4) is emitted from the first, second, third and fourth LED's 28, 30, 32, 34. It is pointed out in FIG. 4 that the harness power cord 12 extends over the plaque 90 and then to the switch assembly 48 (not shown in FIG. 4), and then to the transformer 70 that is plugged into the wall receptacle 75 in order to provide power to the above described LED's. Some of the light exits though the eye socket openings 74 and nostril openings 76, and some of the light 100 is transmitted through the skull 72 to cause the skull 72 to glow in the color of the light 100 that is transmitted through the skull 72. The skull 72 can be made of real bone, or may be synthetic bone and may be embodied as virtually any desired animal skull including mammal, reptile and aquatic creature skulls. It is also envisioned that in other preferred embodiments that the lighting apparatus 10 may be used in a three-dimensional cavernous sculpture or some similar structure rather than a skull.

In another preferred embodiment the switch assembly 46 is not utilized and the lighting harness 12 is powered by a direct DC battery hookup. The present invention can have a plurality of possible configurations including but not limited to any number of lights. With respect to the type of light used, typically LED's are used as they generate very little heat and the light intensity is good, but other types of lights may be used as well, and other power sources may be used. The power source is flexible and may include but is not limited to using batteries (DC), direct wiring (AC), and solar panel designs. Quick connections and on/off switches may be integrated into the design.

The LED's 28, 30, 32, 34 may be controlled with a manual on-off switch that is part of the lighting apparatus 10. For example the receptacle 75 may be under the control of a wall-mounted switch to power the apparatus 10 or power off the lighting apparatus 10. In addition, as shown in FIG. 4, in other preferred embodiments the lighting apparatus 10 can be under the control of a motion sensor 120, a light sensor 130, and/or an audio chip 140 (all shown in dashed lines in FIG. 4) that are in controlling communication with the power source. The motion sensor 120 is preferably on all of the time but may be overridden so that the light does not come on when motion is detected. Likewise, the light sensor 130 is preferably on all of the time but can be overridden so that the light does not come on when light is detected. The audio chip 140 can make a sound and can record an event or audio recording to be played back at a desired time. All of these components may be mounted inside the skull 72 or may be mounted in or on the mount 80 or the table mount 84 or on the wall 82.

The lighting apparatus 10 can be sold as a kit 200 that includes the components shown in FIG. 1, that is, a lighting harness 12, switch assembly 46, and transformer 70. For example, a taxidermist may buy just the lighting apparatus 10 and use his or her own skulls 72. Indeed, the lighting apparatus 10 has many applications for the lights in the field of taxidermy. The lighting apparatus 10 can be installed in full body mounts of animals to light and illuminate virtually any area of the body of the animal in addition to the skull 72. The lighting apparatus 10 can also be used in connection with stuffed animals (not shown). The lighting apparatus 10 may also be used external to the skull 72 such that full mounts can be illuminated from beneath, above, or from the sides. The availability of lights, for example the LED's described herein, that produce little to no heat makes lighting taxidermy from inside and out more feasible.

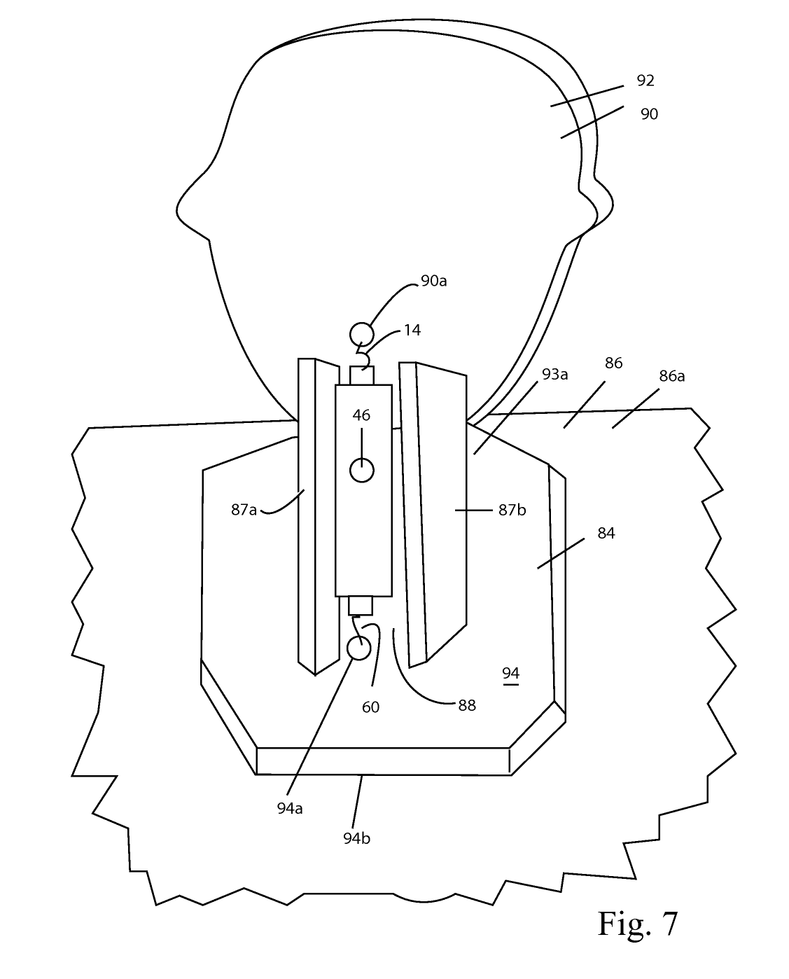

As shown in rear view of FIG. 7, the table mount 84 is supported on a flat surface 86a of the table or shelf 86. In this embodiment a storage compartment connecting member 93a is provided that is embodied to have a pair of spaced apart connecting supports 87a, 87b that interconnect the base member 94 and the plaque 90. A compartment space 88 is defined between the first and second connecting supports 87a, 87b, and the plaque 90. The compartment space 88 is sized to receive the switch assembly 46 therein. The base member 94 defines a base member opening 94a disposed between the first and second connecting members 87a, 87b, through which the power source cord 60 extends. The plaque 90 defines a plaque opening 90a proximal the first and second connecting members 87a, 87b through which the harness power cord 14 extends. The base member 94 also defines a groove 94b on the side opposite from which the first and second connecting supports 87a, 87b extend, and the groove 94b is sized to accommodate the power source cord 60 therein. As shown, the above-described switch assembly 46, power source cord 60 and harness power cord 14 are disposed in an out of the way location such that the table mount 84 is aesthetically pleasing.

Although the lighting apparatus 10 has been explained in relation to its preferred embodiments, it is to be understood that many other possible modifications and variations can be made without departing from the spirit and scope of the lighting apparatus 10 as herein described.

What is claimed is:

1. A lighting apparatus comprising:
a housing;
a lighting harness having a power cord and a wire guide component;
the lighting harness has at least one pair of electrical leads disposed internal to the power cord and wherein the at least one pair of electrical leads extend from beyond the wire guide component, and each of the at least one pair of electrical leads is connected to a light source; and
wherein the at least one pair of electrical leads is disposed internal to the housing.

2. The lighting apparatus of claim 1 wherein the housing is a skull and the light source is a light emitting diode.

3. The lighting apparatus of claim 2 wherein the at least one pair of electrical leads includes four pairs of electrical leads and each of the four pairs of electrical leads is connected to a light emitting diode.

4. The lighting apparatus of claim 3 wherein the four pairs of electrical leads are disposed internally to the skull and are for illuminating the skull.

5. The lighting apparatus of claim 2 further including a wall mount having a plaque that is connected to a connecting member, and a base connected to the connecting member and wherein the base is capable of being supported on a wall.

6. The lighting apparatus of claim 2 further including a table mount having a plaque that is connected to a connecting member, and a base connected to the connecting member and wherein the base is capable of being supported on a table.

7. The lighting apparatus according to claim 5 wherein the plaque defines a plaque opening and the harness power cord is extended through the plaque opening.

8. The lighting apparatus of claim 5 wherein the power cord is adapted to be plugged into a switch assembly, a power source cord having a first power cord source end joined to an electrical socket and adapted to be fitted in the switch assembly, and the power source cord has a second power cord source end that is connected to a transformer, wherein the transformer has prongs adapted to be inserted into a standard receptacle such that power can be delivered to the lighting harness.

9. The lighting apparatus of claim 5 wherein the switch assembly has a switch that is movable between a first and a second position to vary the power delivered to the lighting harness.

10. The lighting apparatus of claim 2 further including at least one of the following: a wall-mounted switch, a motion sensor, a light sensor, and an audio chip to power the apparatus on or off.

11. The lighting apparatus of claim 1 wherein the lighting harness is powered by direct current.

12. The lighting apparatus of claim 7 wherein the power delivered to the transformer is in the form of alternating current.

13. The lighting apparatus of claim 1 wherein the at least one pair of electrical leads includes two pairs of electrical leads.

14. A method for illuminating a housing comprising the acts of:
providing a housing;
providing a lighting harness having a power cord and a wire guide component;
providing the lighting harness with at least one pair of electrical leads and disposing them internal to the power cord and extending the at least one pair of electrical leads beyond the wire guide component,
connecting each of the at least one pair of electrical leads to a light source; and,
disposing the at least one pair of electrical leads internal to the housing.

15. The method for illuminating a housing of claim 14 further including the acts of:
forming the housing in the shape of a skull and providing the light source as a light emitting diode.

16. The method for illuminating a housing of claim 15 further including:
providing a switch assembly;
providing a power source cord having a first power cord source end joined to an electrical socket and fitting the power cord source end in the switch assembly;
providing the power source cord with a second power cord source end and connecting the second power cord source end with a transformer; and,
providing the transformer with prongs adapted to be inserted into a standard receptacle such that power can be delivered to the lighting harness.

17. A lighting apparatus kit comprising:
lighting harness;
a switch assembly;
and a transformer.

18. The lighting apparatus kit according to claim 18 further including a skull and a wall mount.
